(19) United States
(12) Patent Application Publication
(10) Pub. No.: US 2021/0035208 A1
(43) Pub. Date: Feb. 4, 2021

(54) INFORMATION PROCESSING APPARATUS, INFORMATION PROCESSING METHOD, AND PROGRAM

(71) Applicant: NEC Corporation, Minato-ku, Tokyo (JP)

(72) Inventor: Keiji KANDA, Tokyo (JP)

(73) Assignee: NEC Corporation, Minato-ku, Tokyo (JP)

(21) Appl. No.: 17/042,532

(22) PCT Filed: Feb. 25, 2019
(86) PCT No.: PCT/JP2019/006958

§ 371 Date: Sep. 28, 2020

(30) Foreign Application Priority Data
Mar. 28, 2018 (JP) 2018-061274

(51) Int. Cl. G06Q 40/02; G06Q 20/40; G06N 20/00

(52) U.S. Cl. CPC G06Q 40/02; G06N 20/00; G06Q 20/4016

(57) ABSTRACT

An information processing apparatus of the present invention includes a classifying means for setting a class of target data out of data that is a learning target, on the basis of the target data satisfying a predetermined condition, and a model generation means for generating a model for detecting data, on the basis of the target data and the classification set to the target data.

### TECHNICAL FIELD

The present invention relates to an information processing apparatus, an information processing method, and a program, for generating a model to detect data.

### BACKGROUND ART

In recent years, financial transactions such as bank account transactions and stock transactions performed over the network have been spreading. However, in such financial transactions over the network, various illegal financial transactions such as an illegal use of an account and market manipulation are performed, because of an operator being invisible, easy operation, and the like.

In order to prevent illegal financial transactions, it is necessary to keep monitoring illegal actions. Since such monitoring of illegal actions has variations, it is desirable to be performed manually. However, it is difficult to cover the huge amount of network transactions. Therefore, as disclosed in Patent Literature 1, illegal transactions are detected automatically using computers. For example, in Patent Literature 1, a mathematical model having a high possibility of illegality is generated by applying data mining method from log data of transactions, and a transaction conforming to such a mathematical model is detected as an illegal action.

Patent Literature 1: JP 2008-21144 A

### SUMMARY

However, in detection of illegal actions using computers as described above, various illegal actions are detected, which includes a large number of illegal actions having only small effects on financial transactions. Since it is difficult to address all illegal actions having only small effects, it is important to further extract an illegal action having high significance that may cause a large amount of damage, from those illegal actions. Moreover, although it is not necessarily illegal, advance receivable for investment trust or the like also involves differences in the amount of money. Therefore, similar to the cases of illegal actions, it is also important to detect occurrence of advance receivable of high significance that may involves a large amount of money. However, while extraction of illegal actions having high significance as described above must depend on manpower finally, there is a limitation in handling, resulting in a problem that intended illegal actions or the like such as those having high significance on financial transactions cannot be detected efficiently. Such a problem is caused not only in the field of financial transactions but also in detection of an intended event in any field.

In view of the above, an object of the present invention is to provide an information processing apparatus, an information processing method, and a program, capable of solving the aforementioned problem, that is, a problem that an intended event cannot be detected efficiently from data.

An information processing apparatus according to one aspect of the present invention is configured to include

a classifying means for setting a classification of target data out of data that is a learning target, on a basis of the target data satisfying a predetermined condition, and

a model generation means for generating a model for detecting data, on the basis of the target data and the classification set to the target data.

An information processing method according to one aspect of the present invention is configured to include

setting a classification of target data out of data that is a learning target, on the basis of the target data satisfying a predetermined condition, and

generating a model for detecting data, on a basis of the target data and the classification set to the target data.

A program according to one aspect of the present invention is configured to cause an information processing apparatus to realize:

a classifying means for setting a classification of target data out of data that is a learning target, on the basis of the target data satisfying a predetermined condition; and

a model generation means for generating a model for detecting data, on the basis of the target data and the classification set to the target data.

With the configurations described above, the present invention can generate a model enabling efficient detection of an intended event from data.

### BRIEF DESCRIPTION OF DRAWINGS

FIG. 1 is a block diagram illustrating a configuration of an information processing system according to a first exemplary embodiment of the present invention.

FIG. 2 illustrates an example of learning data stored in a learning data storage unit of a learning apparatus disclosed in FIG. 1.

FIG. 3 illustrates an example of risk data stored in a risk data storage unit of the learning apparatus disclosed in FIG. 1.

FIG. 4 illustrates an example in which a risk-considered illegality flag is set to the learning data disclosed in FIG. 1.

FIG. 5 is a flowchart illustrating an operation of the learning apparatus disclosed in FIG. 1.

FIG. 6 illustrates an operation of the information processing system disclosed in FIG. 1.

FIG. 7 illustrates an operation of another system related to the information processing system of the present invention.

FIG. 8 is a block diagram illustrating a configuration of an information processing apparatus according to a second exemplary embodiment of the present invention.

### EXEMPLARY EMBODIMENTS

### First Exemplary Embodiment

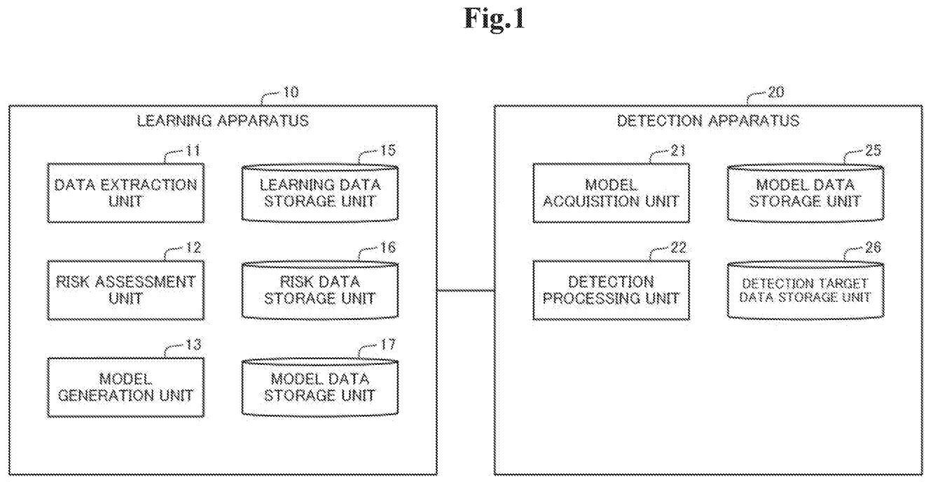

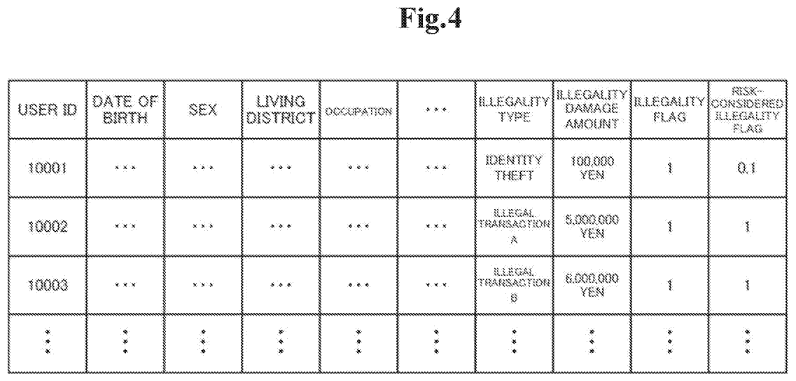

A first exemplary embodiment of the present invention will be described with reference to FIGS. 1 to 6. FIGS. 1 to 3 are drawings for explaining a configuration of an information processing system, and FIGS. 4 to 6 are drawings for explaining the operation of the information processing system.

An information processing system of the present embodiment is intended to process data to be used for financial transactions such as bank account transactions and stock transactions. The information processing system is configured to generate a model for detecting an illegal transaction from financial transaction data in which an illegal action has been found and, with use of the generated model, detect an illegal transaction that may be newly caused.

### Configuration

As illustrated in FIG. 1, the information processing system is configured to include a learning apparatus 10 and a detection apparatus 20. The learning apparatus 10 performs processing of generating a model for detecting an illegal transaction that is an intended event, from learning data to be learned. The detection apparatus 20 performs processing of detecting an illegal transaction that is an intended event from detection target data that is a detection target, with use of the model generated by the learning apparatus 10.

It is not limited that the learning apparatus 10 and the detection apparatus 20 are configured of different information processing apparatuses, respectively. They may be configured of one information processing apparatus. Further, it is not limited that each of the learning apparatus 10 and the detection apparatus 20 is configured of one information processing apparatus. Each of them may be configured of a plurality of information processing apparatuses. Hereinafter, the configuration of each of the apparatuses 10 and 20 will be described in detail.

The learning apparatus 10 is configured of an information processing apparatus having an arithmetic unit and a storage unit. As illustrated in FIG. 1, the learning apparatus 10 includes a data extraction unit 11, a risk assessment unit 12, and a model generation unit 13 that are constructed by execution of a program by the arithmetic unit. The learning apparatus 10 also includes a learning data storage unit 15, a risk data storage unit 16, and a model data storage unit 17 that are formed in the storage unit.

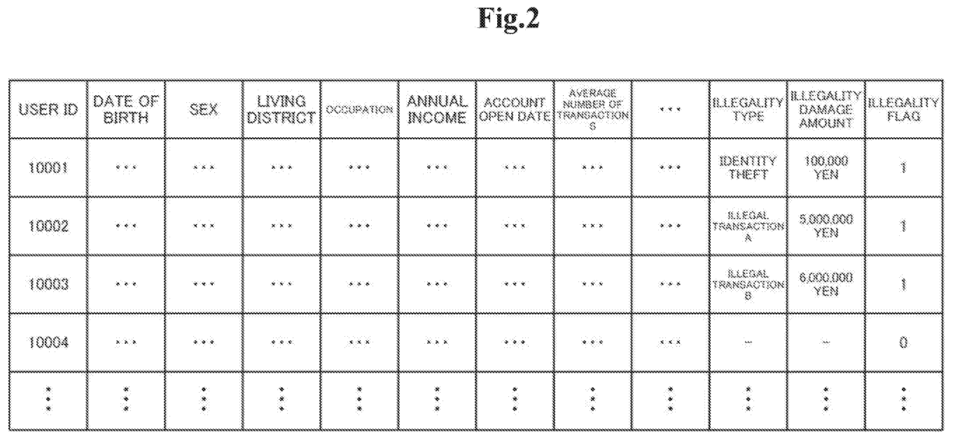

The learning data storage unit 15 stores therein learning data to be learned. The learning data in the present embodiment is data used in financial transactions. FIG. 2 illustrates an example thereof. As illustrated in FIG. 2, the learning data includes a plurality of attributes including, in addition to attributes of user personal information such as a user ID, date of birth, and sex, attributes of information related to transactions such as account open date and the average number of transactions. The learning data also includes attributes related to an illegal action such as a flag representing presence or absence of an illegal action in a financial transaction (illegality flag), the amount of damage caused by an illegal action (illegality damage amount), and the type of illegal action (illegality type).

The data extraction unit 11 reads the learning data stored in the learning data storage unit 15, and at the time of generating a model, extracts target data on which risk assessment is to be performed, as described later. At that time, as target data, data in which the attribute “illegality flag” is “1”, that is, data involving an illegal action, is extracted. While data involving an illegal action in the learning data is used as target data in this example, data of a financial transaction involving damage, regardless of presence or absence of an illegal action, may be extracted as target data.

The risk assessment unit 12 (classifying means) performs risk assessment on the target data that involves an illegal action and is extracted, as described above. Specifically, the risk assessment unit 12 first checks the value of an attribute of the target data. Here, the value of the “amount of damage” by the illegal action is checked. Then, the risk assessment unit 12 assesses the risk indicating the degree of significance of the illegal action involved in the target data, from the value of the “amount of damage” caused by the illegal action in the target data. Thereafter, the risk assessment unit 12 sets a “risk coefficient” having been set according to the degree of risk assessed, as a “risk-considered illegality flag” in place of the “illegality flag”. At that time, the risk assessment by the risk assessment unit 12 is performed based on the risk data stored in the risk data storage unit 16 by the learning apparatus 10.

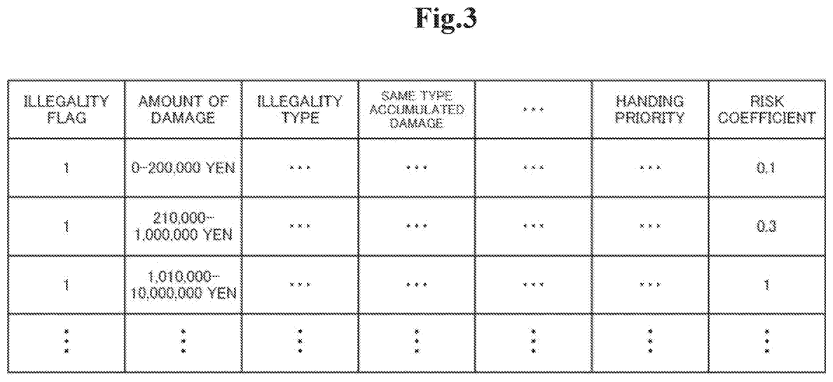

FIG. 3 illustrates an example of risk data (classification data) stored in the risk data storage unit 16 (classification data storing means). As illustrated in FIG. 3, the risk data includes, as the attributes thereof, an illegality flag, the amount of damage, illegality type, the same type accumulated damage, handling priority, and a risk coefficient. In particular, the risk data of the present embodiment represents the correspondence relationship between the “amount of damage” and the “risk coefficient”, and is set in such a manner that the value of the “risk coefficient” is higher as the value of the “damage” is larger. Specifically, in the example of FIG. 3, the risk data on the first row indicates that the “amount of damage” is “0 to 200,000 yen” and the “risk coefficient” is “0.1”. The risk data on the second row indicates that the “amount of damage” is “210,000 to 1,000,000 yen” and the “risk coefficient” is “0.3”. The risk data on the third row indicates that the “amount of damage” is “1,010,000 to 10,000,000 yen” and the “risk coefficient” is “1”. As described above, it is considered that as the “amount of damage” is larger, the significance of the target data as an illegal transaction is higher. Therefore, the “risk coefficient” is set to be higher.

As described above, on the basis of the risk data, the risk assessment unit 12 sets, to the target data, the “risk coefficient” corresponding to the value of the “amount of damage” that is a specific attribute of the target data, as a risk-considered illegality flag. That is, the risk assessment unit 12 classifies the target data to a classification indicated by the value of the “risk coefficient” according to the “amount of damage”. Then, the “risk-considered illegality flag” that is a value of the “risk coefficient” set to the target data serves as a weight for the target data to be used for generating a model, as described below.

For example, in the target data of a user ID “10001” shown on the first row of FIG. 2, the illegality damage amount is “100,000 yen”. Therefore, on the basis of the risk data of FIG. 3, it is classified to a classification of risk coefficient “0.1”, and the risk coefficient “0.1” is set as a “risk-considered illegality flag” as shown on the first row of FIG. 4. Similarly, in the target data of a user ID “10002” shown on the second row of FIG. 2, the illegality damage is “5,000,000 yen”. Therefore, on the basis of the risk data of FIG. 3, it is classified to a classification of a risk coefficient “1”, and the risk coefficient “1” is set as a “risk-considered illegality flag” as shown on the second row of FIG. 4.

While the risk data representing the correspondence relationship between the “amount of damage” and the “risk coefficient” is illustrated as an example of risk data, the risk data may be one representing a correspondence relationship between a value of another attribute of the target data and the “risk coefficient”. For example, in the risk data, the “risk coefficient” may be set according to the value of the attribute “illegality type” of the target data. For example, the “risk coefficient” may be set in such a manner that if the “illegality type” is “identity theft”, the value of “risk coefficient” is small, while if the “illegality type” is “illegal transaction A”, the value of “risk coefficient” is large. Further, the risk data may represent a correspondence relationship between values of a plurality of attributes of target data and the “risk coefficient”. In that case, the value of the “risk coefficient” of the target data is set according to the values of the attributes of the target data.

The model generation unit 13 (model generation means) performs learning based on the value of each attribute of the target data to which a risk-considered illegality flag is set, and generates a model for detecting financial transaction data corresponding to an illegal action. At that time, the model generation unit 13 generates a model enabling detection of data of a financial transaction involving a large amount of damage by placing higher significance on target data in which the value of the risk-considered illegality flag is larger. As an example, the model generation unit 13 uses the target data out of the learning data to generate a model for detecting financial transaction data in which the value of the risk-considered illegality flag is large, with the value of the attribute of the target data being used as an explanatory variable and the risk-considered illegality flag being used as an objective variable. Note that generation of a model may be performed by any method including learning data in which the illegality flag is “0”, that is, no illegal action was made.

Upon generation of the model, the model generation unit 13 stores the model data in the model data storage unit 17 provided in the learning apparatus 10. The model generation unit 13 also transmits the generated model data to the detection apparatus 20.

Here, when the risk assessment unit 12 and/or the model generation unit 13 (classification data generation means) performs risk assessment on the target data, and/or generates a model using the target data, the risk assessment unit 12 and/or the model generation unit 13 may generate new risk data to update the risk data in the risk data storage unit 16. For example, in the process of checking a plurality of pieces of target data during risk assessment and generation of a model, when an attribute in which the degree of significance of an illegal action can be distinguished is found, the risk assessment unit 12 and/or the model generation unit 13 generates risk data representing a correspondence relationship between such an attribute and the risk coefficient. As an example, the risk assessment unit 12 and the model generation unit 13 may generate risk data representing a correspondence relationship between a new range of the amount of damage and a risk coefficient, from the distribution of the attribute “amount of damage” of the target data, or generate risk data representing a correspondence relationship between a combination of a plurality of attributes of the target data and a risk coefficient.

Next, the detection apparatus 20 will be described. The detection apparatus 20 is configured of an information processing apparatus having an arithmetic unit and a storage unit. As illustrated in FIG. 1, the detection apparatus 20 includes a model acquisition unit 21 and a detection processing unit 22 that are constructed by execution of a program by the arithmetic unit. The detection apparatus 20 also includes a model data storage unit 25 and a detection target data storage unit 26 that are formed in the storage unit.

The model acquisition unit 21 acquires the model data generated in the learning apparatus 10 from the learning apparatus 10, and stores it in the model data storage unit 25. Then, the detection processing unit 22 (data detection means) uses the model data acquired from the learning apparatus 10 to perform detection processing on the financial transaction data that is a detection target stored in the detection target data storage unit 26. In the present embodiment, since the model data is generated by increasing the weight of the data in which the attribute “amount of damage” of financial transaction data is larger as described above, data in which the “amount of damage” is supposed to be large is detected by using such model data.

Note that the detection processing unit 22 may output detected data to the outside from an output device such as a display device or a printing device. In that case, the detection processing unit 22 may output it in any form. For example, it may output a list of “user ID” of detected users and the supposed “amount of damage”, or output detected data by sorting it in the descending order of the supposed values of the “amount of damage”.

### Operation

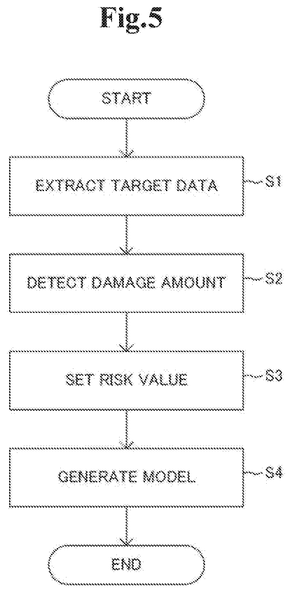

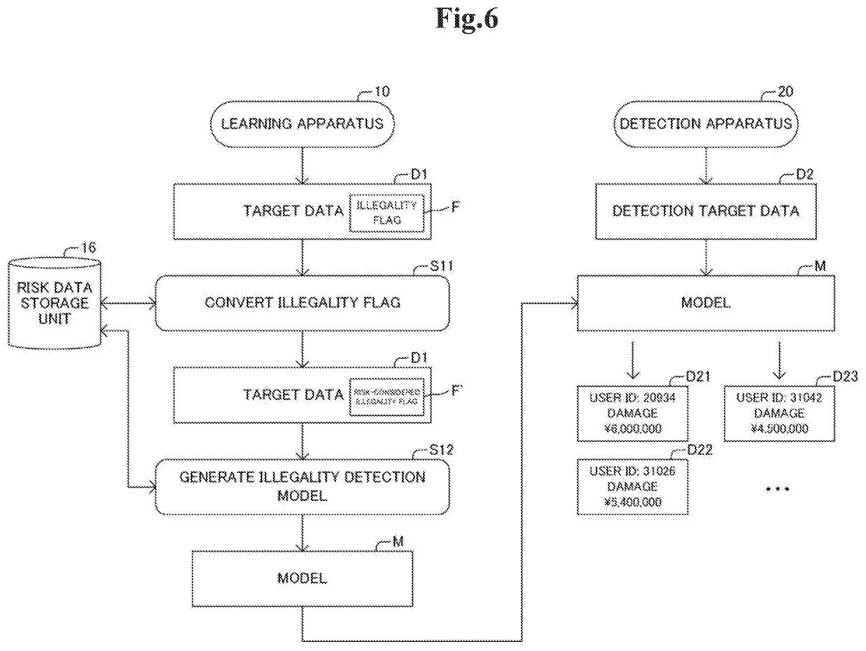

Next, operation of the information processing system described above will be described with reference to FIGS. 5 to 7. First, operation in the case of the present embodiment will be described with reference to FIGS. 5 and 6. Note that FIG. 5 illustrates the operation of the learning apparatus 10, and FIG. 6 illustrates the operation of the entire information processing system.

First, the learning apparatus 10 reads the learning data stored in the learning data storage unit 15, and extracts target data on which risk assessment is to be performed for generating a model (step S1 of FIG. 5). At that time, data in which the attribute “illegality flag” of the learning data is “1”, that is, data involving an illegal action, is extracted as target data D1.

Then, the learning apparatus 10 performs risk assessment on the target data. Specifically, the learning apparatus 10 first checks the value of the attribute “amount of damage” of the target data (step S2 of FIG. 5). Then, the learning apparatus 10 refers to the risk data in the risk data storage unit 16 to specify a “risk coefficient” (classification) corresponding to the value of the “amount of damage” caused by the illegal action of the target data D1. Thereafter, the learning apparatus 10 sets the specified risk coefficient as a new risk-considered illegality flag F′, in place of a previous illegality flag F of the target data D1 (step S3 of FIG. 5, step S11 of FIG. 6).

Then, the learning apparatus 10 performs learning using the target data D1 to which the risk-considered illegality flag F′ is set, and generates a model M for detecting financial transaction data corresponding to an illegal action (step S4 of FIG. 5, step S12 of FIG. 6). The learning apparatus 10 transmits the generated model M to the detection apparatus 20.

Thereafter, the detection apparatus 20 performs detection processing on the financial transaction data that is detection target data D2, using the model M generated by the learning apparatus 10. In the present embodiment, since the model M is generated by increasing the weight of the data in which the attribute “amount of damage” of the financial transaction data is larger as indicated by the reference signs D21 to D23 in FIG. 6, data in which the “amount of damage” is supposed to be large is detected.

Note that when performing risk assessment on the target data D1 (step S11 of FIG. 6) and generating the model M using the target data D1 (step S12 of FIG. 6), the learning apparatus 10 may generate new risk data with reference to the attribute of the target data D1 and update the risk data in the risk data storage unit 16.

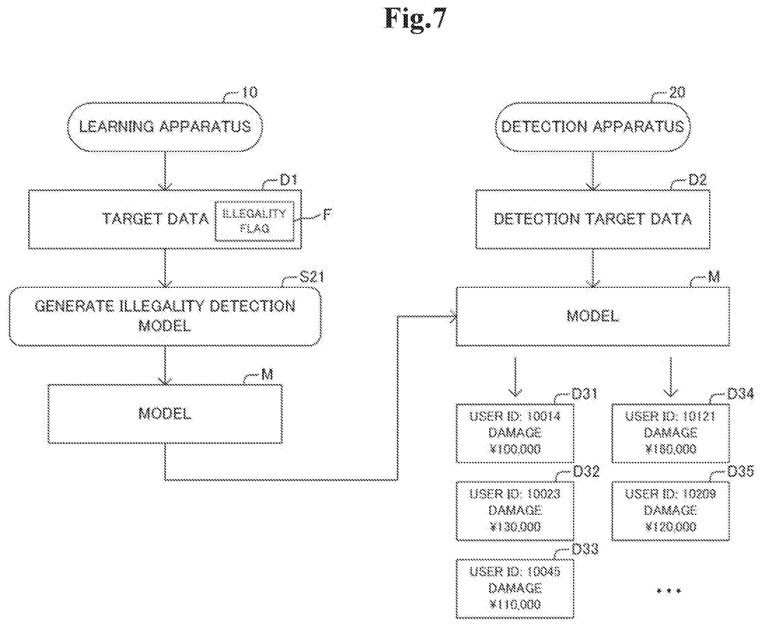

Here, an example of generating a model without setting a risk-considered illegality flag, which is different from the present invention described above, will be described with reference to FIG. 7. In this example, risk assessment of the target data D1 is not performed and the risk-considered illegality flag F′ is not given to the target data D1, unlike the present invention. That is, in the example illustrated in FIG. 7, a model M′ for detecting financial transaction data corresponding to an illegal action is generated by using the target data D1 to which only the illegality flag F indicating whether or not an illegality is performed is given (step S21 of FIG. 7).

In the example described above, since the model M′ is generated by using every target data D1 in which an illegal transaction was made without taking into account the value of the amount of damage, in the detection performed on the detection target data D2 using the model M′, every financial transaction data that is supposed to be an illegal transaction is detected. Therefore, as indicated by the reference signs D31 to D35 of FIG. 7, a large number of units of data, including data in which the “amount of damage” is supposed to be small, are detected.

As described above, in the information processing system of the present embodiment, it is possible to generate a model enabling detection of financial transaction data that may be an illegal transaction involving a large amount of damage that may seriously affect the financial transactions. While, in the above description, an example of the case where risk assessment is performed by focusing on the attribute “amount of damage” of financial transaction data is shown, the attribute to be focused for risk assessment may be changed depending on the risk data. Therefore, data of an event related to the value of another attribute can be detected.

Further, while, in the above description, a case of detecting an illegal action or an illegal transaction has been illustrated as an example, in the present invention, a detection target is not necessarily limited to an illegal action or an illegal transaction. That is, in the present invention, any event may be handled as a detection target if it is an event that may damage a person or an organization, regardless of whether or not occurrence of the damage is caused by illegality.

Moreover, while, in the above description, the case where a processing target is financial transaction data is illustrated as an example, in the present invention, processing target data is not necessarily limited to financial transaction data. That is, in the present invention, any data may be a processing target, and the present invention may generate a model for detecting data of any event from such data.

As an example, in the present invention, data related to a human being may be handled as a processing target. In that case, from data of a person having suffered from a specific disease, an attribute related to the specific disease is focused, and the data is weighted according to the value of such an attribute. Then, by generating a model using the weighted data, data of a person who may be suffering from the specific disease can be detected.

### Second Exemplary Embodiment

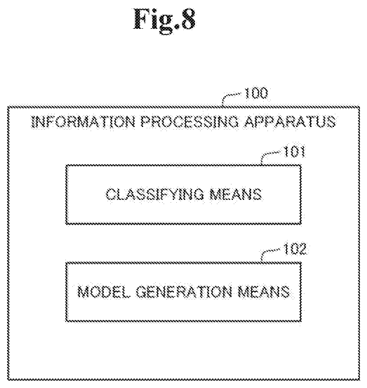

Next, a second exemplary embodiment of the present invention will be described with reference to FIG. 8. FIG. 8 is a block diagram illustrating a configuration of an information processing apparatus according to the second exemplary embodiment. Note that the present embodiment shows the outline of the configuration of the learning apparatus 10 described in the first exemplary embodiments.

As illustrated in FIG. 8, an information processing apparatus 100 of the present embodiment includes

a classifying means 101 for setting a classification of target data out of data that is a learning target, on the basis of the target data satisfying a predetermined condition, and

a model generation means 102 for generating a model for detecting data, on the basis of the target data and the classification set to the target data.

Note that the classifying means 101 and the model generation means 102 are implemented by execution of a program by the information processing apparatus.

The information processing apparatus 100 having the above-described configuration operates to execute processing of

setting a classification of target data out of data that is a learning target, on the basis of the target data satisfying a predetermined condition, and

generating a model for detecting data, on the basis of the target data and the classification set to the target data.

According to the invention described above, target data satisfying a predetermined condition is classified and a model is generated from the target data in consideration of the classification. Therefore, by using such a model, it is possible to detect data of an intended event according to the classification set.

### Supplementary Notes

The whole or part of the exemplary embodiments disclosed above can be described as, but not limited to, the following supplementary notes. Hereinafter, outlines of the configurations of an information processing apparatus, an information processing method, and a program, according to the present invention, will be described. However, the present invention is not limited to the configurations described below.

### Supplementary Note 1

An information processing apparatus comprising:

classifying means for setting a classification of target data out of data that is a learning target, on a basis of the target data satisfying a predetermined condition; and

model generation means for generating a model for detecting data, on a basis of the target data and the classification set to the target data.

### Supplementary Note 2

The information processing apparatus according to supplementary note 1, wherein

the classifying means sets the classification of the target data on a basis of a value of an attribute constituting the target data.

### Supplementary Note 3

The information processing apparatus according to supplementary note 1 or 2, wherein

the classifying means sets a weight having a predetermined value as the classification of the target data, and

the model generation means generates the model on a basis of the target data and the weight set to the target data.

### Supplementary Note 4

The information processing apparatus according to supplementary note 3, wherein

the classifying means sets, to the target data, the weight having a value that is larger as a degree of significance is higher, the degree of significance being determined based on a preset criterion according to a value of an attribute constituting the target data.

### Supplementary Note 5

The information processing apparatus according to any of supplementary notes 1 to 4, further comprising:

classification data storage means for storing classification data representing a correspondence relationship between a value of an attribute constituting the target data and the classification; and

classification data generation means for generating new classification data and updating the classification data, on a basis of the value of the attribute constituting the target data.

### Supplementary Note 6

The information processing apparatus according to any of supplementary notes 1 to 5, wherein

the classifying means sets the classification of the target data on a basis of a value of an amount of money constituting the target data that is financial transaction data of a transaction involving a damage, out of financial transaction data that is the learning target.

### Supplementary Note 7

The information processing apparatus according to supplementary note 6, wherein

the classifying means sets, to the target data, a weight as the classification, the weight having a value that is larger as the value of the amount of money constituting the target data is larger, and

the model generation means generates the model on a basis of the target data and the weight set to the target data.

### Supplementary Note 8

The information processing apparatus according to any of supplementary notes 1 to 7, further comprising

data detection means for detecting data with use of the model, from data that is a detection target.

### Supplementary Note 9

An information processing method comprising:

setting a classification of target data out of data that is a learning target, on a basis of the target data satisfying a predetermined condition; and

generating a model for detecting data, on a basis of the target data and the classification set to the target data.

### Supplementary Note 9.1

The information processing method according to supplementary note 9, further comprising

setting the classification of the target data on a basis of a value of an attribute constituting the target data.

### Supplementary Note 9.2

The information processing method according to claim 9 or 9.1, further comprising

setting a weight having a predetermined value as the classification of the target data, and

generating the model on a basis of the target data and the weight set to the target data.

### Supplementary Note 9.3

The information processing method according to supplementary note 9.2, further comprising

setting, to the target data, the weight having a value that is larger as a degree of significance is higher, the degree of significance being determined based on a preset criterion according to a value of an attribute constituting the target data.

### Supplementary Note 9.4

The information processing method according to any of supplementary notes 9 to 9.3, further comprising:

storing classification data representing a correspondence relationship between a value of an attribute constituting the target data and the classification; and

setting the classification of the target data on a basis of the value of the attribute constituting the target data with use of the classification data, and setting a new classification and updating the classification data on the basis of the value of the attribute constituting the target data.

### Supplementary Note 9.5

The information processing method according to any of supplementary notes 9 to 9.4, further comprising

detecting data matching the generated model, from data that is a detection target.

### Supplementary Note 10

A program for causing an information processing apparatus to realize:

classifying means for setting a classification of target data out of data that is a learning target, on a basis of the target data satisfying a predetermined condition; and

model generation means for generating a model for detecting data, on a basis of the target data and the classification set to the target data.

### Supplementary Note 10.1

The program, according to supplementary note 15, for causing the information processing apparatus to further realize

data detection means for detecting data matching the model, from data that is a detection target.

Note that the program described above is stored using a non-transitory computer readable medium of any type, and can be supplied to a computer. A non-transitory computer readable medium includes a tangible storage medium of any type. Examples of a non-transitory computer readable medium include a magnetic recording medium (for example, flexible disk, magnetic tape, hard disk drive), a magneto-optical recording medium (for example, magneto-optical disk), a CD-ROM (Read Only Memory), a CD-R, a CD-R/W, and a semiconductor memory (for example, a mask ROM, a PROM (Programmable ROM), an EPROM (Erasable PROM), a flash ROM, and a RAM (Random Access Memory)). Further, the program may be supplied to a computer by a transitory computer readable medium of any type. Examples of a transitory computer readable medium include an electrical signal, an optical signal, and an electromagnetic wave. A transitory computer readable medium can supply the program to a computer via a wired communication channel such as an electric wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2018-061274, filed on Mar. 28, 2018, the disclosure of which is incorporated herein in its entirety by reference.

### REFERENCE SIGNS LIST

10 learning apparatus
11 data extraction unit
12 risk assessment unit
13 model generation unit
15 learning data storage unit
16 risk data storage unit
17 model data storage unit
20 detection apparatus
21 model acquisition unit
22 detection processing unit
25 model data storage unit
26 detection target data storage unit
100 information processing apparatus
101 classifying means
102 model generation means

What is claimed is:

1. An information processing apparatus comprising:
a memory in which processing instructions are stored; and
at least one processor configured to execute the processing instructions, wherein
the at least one processor is configured to execute processing of:
setting a classification of target data out of data that is a learning target, on a basis of the target data satisfying a predetermined condition; and
generating a model for detecting data, on a basis of the target data and the classification set to the target data.

2. The information processing apparatus according to claim 1, wherein
the at least one processor sets the classification of the target data on a basis of a value of an attribute constituting the target data.

3. The information processing apparatus according to claim 1, wherein
the at least one processor
sets a weight having a predetermined value as the classification of the target data, and
generates the model on a basis of the target data and the weight set to the target data.

4. The information processing apparatus according to claim 3, wherein
the at least one processor sets, to the target data, the weight having a value that is larger as a degree of significance is higher, the degree of significance being determined based on a preset criterion according to a value of an attribute constituting the target data.

5. The information processing apparatus according to claim 1, wherein the at least one processor:
stores classification data representing a correspondence relationship between a value of an attribute constituting the target data and the classification; and
generates new classification data and updates the classification data, on a basis of the value of the attribute constituting the target data.

6. The information processing apparatus according to claim 1, wherein
the at least one processor sets the classification of the target data on a basis of a value of an amount of money constituting the target data that is financial transaction data of a transaction involving a damage, out of financial transaction data that is the learning target.

7. The information processing apparatus according to claim 6, wherein
the at least one processor
sets, to the target data, a weight as the classification, the weight having a value that is larger as the value of the amount of money constituting the target data is larger, and
generates the model on a basis of the target data and the weight set to the target data.

8. The information processing apparatus according to claim 1, wherein
the at least one processor detects data with use of the model, from data that is a detection target.

9. An information processing method comprising:
setting a classification of target data out of data that is a learning target, on a basis of the target data satisfying a predetermined condition; and
generating a model for detecting data, on a basis of the target data and the classification set to the target data.

10. The information processing method according to claim 9, further comprising
setting the classification of the target data on a basis of a value of an attribute constituting the target data.

11. The information processing method according to claim 9, further comprising:
setting a weight having a predetermined value as the classification of the target data; and
generating the model on a basis of the target data and the weight set to the target data.

12. The information processing method according to claim 11, further comprising
setting, to the target data, the weight having a value that is larger as a degree of significance is higher, the degree of significance being determined based on a preset criterion according to a value of an attribute constituting the target data.

13. The information processing method according to claim 9, further comprising:
storing classification data representing a correspondence relationship between a value of an attribute constituting the target data and the classification; and
setting the classification of the target data on a basis of the value of the attribute constituting the target data with use of the classification data, and setting a new classification and updating the classification data on the basis of the value of the attribute constituting the target data.

14. The information processing method according to claim 9, further comprising
detecting data matching the generated model, from data that is a detection target.

15. A non-transitory computer-readable medium storing a program comprising instructions for causing an information processing apparatus to perform processing of:
setting a classification of target data out of data that is a learning target, on a basis of the target data satisfying a predetermined condition; and
generating a model for detecting data, on a basis of the target data and the classification set to the target data.

16. The non-transitory computer-readable medium storing the program, according to claim 15, for causing the information processing apparatus to further perform processing of
detecting data matching the model, from data that is a detection target.
